(19) United States
(12) Patent Application Publication
(10) Pub. No.: US 2007/0296254 A1
(43) Pub. Date: Dec. 27, 2007

(54) CHILD SEAT SAFETY SYSTEM

(76) Inventor: Michael Robert Kahn, Westampton, NJ (US)

Correspondence Address: MICHAEL R. KAHN, P.O. BOX 184, MOUNT HOLLY, NJ, 08060, US

(21) Appl. No.: 11/380,928

(22) Filed: Apr. 29, 2006

Related U.S. Application Data
(60) Provisional application No. 60/714,438, filed on Sep. 6, 2005.

(51) Int. Cl. A47C 1/11; F21V 7/04; G08B 21/00; H02J 7/00

(52) U.S. Cl. 297/256.16; 320/107; 340/667; 362/612

(57) ABSTRACT

The present invention comprises an infant carrier and a mating base which combine to form an infant carrier/car seat combination. The infant carrier has a seat belt system within it to properly secure the infant. When the infant carrier is attached to the base, and the infant carrier seat belt system is not fastened, a notification is generated. When the infant carrier is not properly fastened to the base, a notification may also be generated. Additionally, a confirmation notification may be generated when the seat belt is fastened and the infant carrier is properly fastened to the base. This notification may comprise audible, visual, or tactile indications, or a combination of the aforementioned indications. The indications may include, but are not limited to, a buzzer, a flashing light, or a vibrator in the handle of the infant carrier.

### CROSS REFERENCE TO RELATED PUBLICATIONS

This application claims the benefit of U.S. Provisional Application No. 60/714,438, filed Sep. 6, 2005 and is incorporated herein in its entirety.

### FIELD OF THE INVENTION

This invention relates to an infant carrier and receiving base. More specifically, this invention relates to an infant carrier and receiving base with improved safety features.

### BACKGROUND OF THE INVENTION

Infant carriers are well-known and used to easily carry an infant from place-to-place as well as seating for an infant for sleeping, feeding, or playing. These carriers are generally a plastic shell with a seating surface, sides, an adjustable carry handle, rocker-shaped bottom runners, a restraint harness, a carry handle and a pad.

Infant carriers are often used as infant car seats with the addition of a base. The base has a somewhat torso-shaped contour over which an automobile seatbelt is passed to secure the base in the automobile. The carrier is then attached to the base in some way.

It may sometimes happen that when the caregiver places the infant carrier on the base, that the infant carrier is not completely latched onto the base. In this case, the infant is at risk in the event of an accident. Furthermore, even if the infant carrier is securely attached to the base, there are still other potential dangers that may compromise infant safety. For example, when the infant carrier is used outside of the automobile for sleeping, feeding or playing, the infant might not be securely buckled into the infant carrier. Furthermore, it is common to cover the infant with a blanket while sleeping or feeding in the infant carrier. The blanket obscures the fact that the infant is not properly buckled. Unfortunately, the caregiver may forget that the infant is not properly buckled, and secure the infant carrier onto the base for the purposes of traveling in an automobile. In these cases, the caregiver is unknowingly traveling with the infant not properly buckled. If the automobile were to be involved in an accident, substantial harm, or even death, may result to the infant. What is needed is an apparatus that alerts the caregiver to these safety conditions, thereby allowing the caregiver to ensure the infant is properly secured before traveling in an automobile.

### SUMMARY OF THE INVENTION

The invention comprises an infant carrier and a mating base which combine to form an infant carrier/car seat combination. The infant carrier has a seat belt system within it to properly secure the infant. When the infant carrier is attached to the base, and the infant carrier seat belt system is not fastened, a notification is generated. This notification may comprise audible, visual, or tactile indications, or a combination of the aforementioned indications. The indications may include, but are not limited to, a buzzer, a flashing light, or a vibrator in the handle of the infant carrier.

It is an aspect of the present invention to provide an indication when the infant carrier is connected to the base, and the infant carrier seat belt system is not fastened.

It is another aspect of the present invention to provide low power indication when the infant carrier is connected to the base and the voltage of the power source is below a certain threshold.

It is another aspect of the present invention to provide an indication that the infant carrier is properly connected to the base.

It is another aspect of the present invention to provide an indication that the infant carrier is properly connected to the base, and that the infant carrier seat belt is fastened.

It is another aspect of the present invention to provide a child seat safety system, comprising an infant carrier having a seat belt, a base to which the infant carrier can be fastened, a plurality of positional sensors installed on the base and the infant carrier, thereby forming a plurality of positional sensor pairs, monitoring means for monitoring the status of each of the positional sensor pairs, generating means for generating an alert signal when at least one positional sensor pair is not coupled, and indication means for indicating the presence of the alert signal to a user.

It is another aspect of the present invention to provide means for detecting a low battery voltage condition, generating a low battery signal upon detection of the low battery voltage condition, and indication means for indicating the low battery voltage condition to a user.

It is another aspect of the present invention to provide means for generating a confirmation indication signal when the infant carrier is properly inserted into the base, and indication means for indicating the presence of the confirmation indication signal to a user.

It is another aspect of the present invention to have a battery power source.

It is another aspect of the present invention to have means for receiving power from an external power supply.

It is another aspect of the present invention to have means for receiving power from an external power supply, whereby the battery power source is disconnected when power is supplied from the external power supply.

It is another aspect of the present invention to have a battery power source that is rechargeable.

It is another aspect of the present invention to have an indication means that includes a speaker.

It is another aspect of the present invention to have an indication means that includes one or more light elements.

It is another aspect of the present invention to have light elements that are light emitting diodes.

It is another aspect of the present invention to have at least one set of positional sensors pairs being comprised of contact sensors.

It is another aspect of the present invention to have at least one set of positional sensors pairs being comprised of proximity sensors.

It is another aspect of the present invention to have means for detecting an unbuckled seat belt when the infant carrier is fastened to the base, the means comprising means for generating an unbuckled signal upon detection of an unbuckled seat belt, and indication means for indicating the unbuckled seat belt condition to a user.

### BRIEF DESCRIPTION OF THE DRAWINGS

FIG. 1 is a block diagram of an embodiment of the present invention.

FIG. 2 is a block diagram of another embodiment of the present invention.

FIG. 3 is a block diagram of yet another embodiment of the present invention.

FIG. 4 is a side view of an embodiment of the present invention.

FIG. 5 is a side view of another embodiment of the present invention.

### DETAILED DESCRIPTION OF PREFERRED EMBODIMENTS

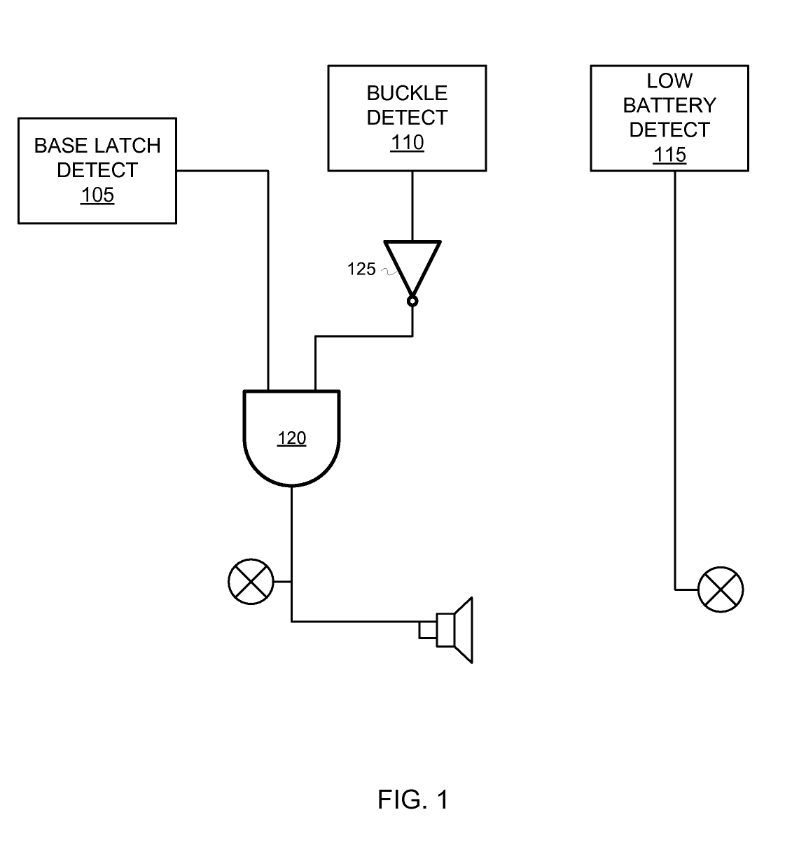

FIG. 1 is a block diagram of an embodiment of the present invention. This embodiment uses three detection circuits, base latch detect 105, buckle detect 110, and low battery detect 115. Base latch detect 105 asserts a signal when the infant carrier 210 is latched to base 205. Buckle detect 110 asserts a signal when the seat belt 217 in infant carrier 210 is buckled. The output of buckle detect 110 is inverted via inverter 125, thereby providing an “unbuckled” signal that is asserted when the buckle is unbuckled. The output of inverter 125 and the output of base latch detect 105 are input to logical AND gate 120. The output of AND gate 120, when asserted, is used to activate a light element. The light element may be a small lamp or light emitting diode (LED), and produce a tone from a speaker or buzzer. In this configuration, the user is provided a visual and aural notification when the infant carrier is secured to the base and the buckle is not fastened. This may be indicative of a situation where an infant was placed in the automobile without being buckled. Low battery detect 115 illuminates a lamp or LED when the battery voltage falls below a predetermined level.

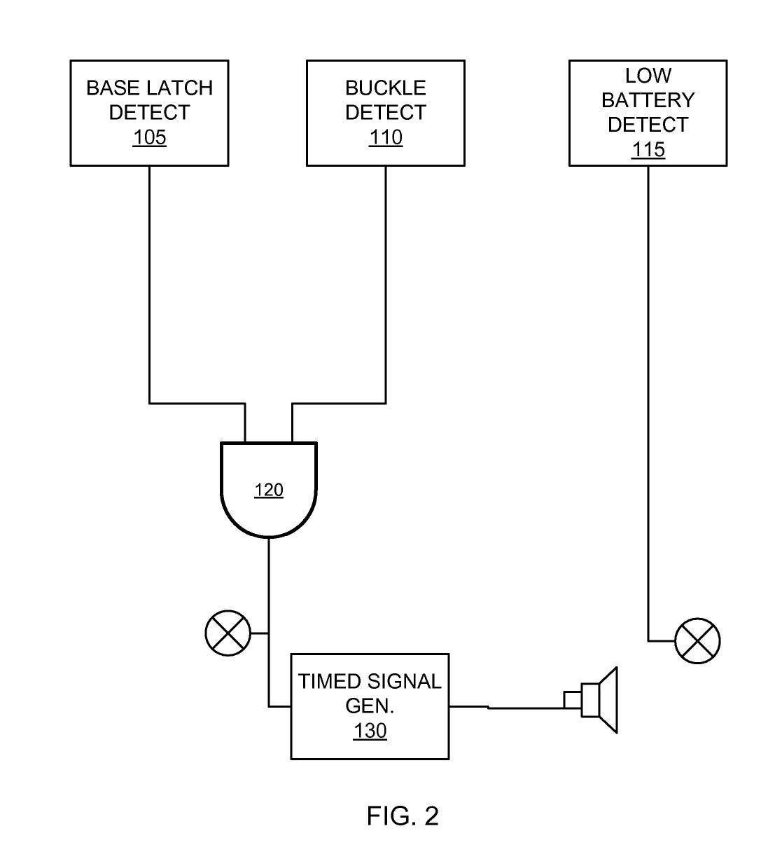

FIG. 2 is a block diagram of another embodiment of the present invention. In this embodiment, a confirmation indication is provided when the infant carrier 210 is properly inserted into base 205. The output of base latch detect 105 and buckle detect 110 are input to AND gate 125. The output of AND gate 125, when asserted, is used to activate a small lamp or light emitting diode (LED), and activate timed signal generator 130. The output of timed signal generator 130 produces a limited duration tone from a speaker or buzzer. In this configuration, the user is provided a positive confirmation that the infant carrier 210 has been properly installed on base 205. The indication includes a visual indication, such as a small lamp or LED. An aural indication is provided as well, such as a buzzer or chime that sounds for a few seconds. In this way, the user receives confirmation of a proper install each time they place the infant carrier 210 on base 205. Low battery detect 115 illuminates a lamp or LED when the battery voltage falls below a predetermined level.

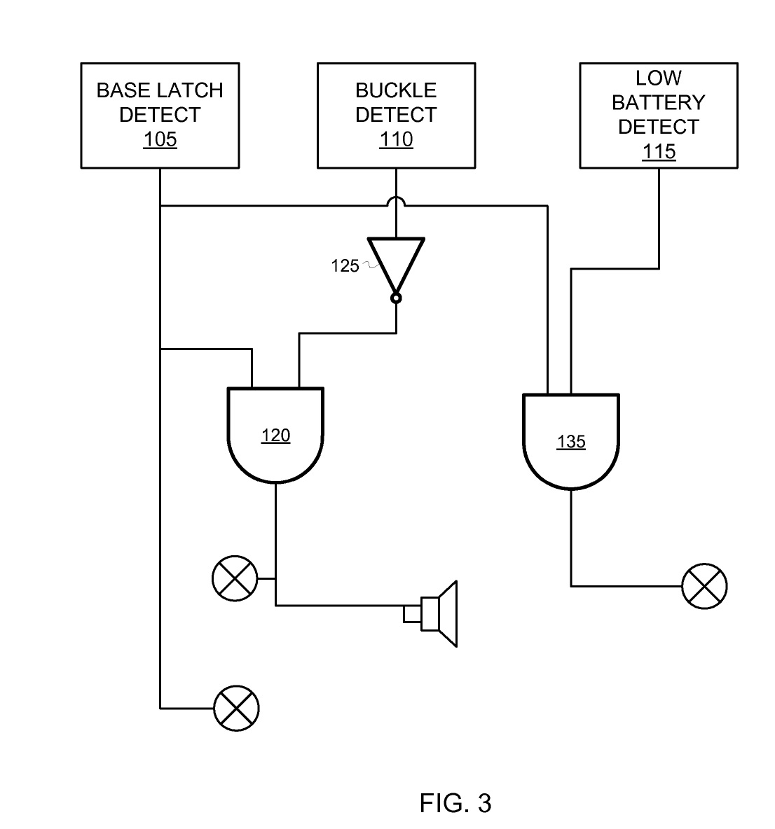

FIG. 3 is a block diagram of yet another embodiment of the present invention. Similar to the embodiment of FIG. 1, the user is provided a visual and aural notification when the infant carrier is secured to the base and the buckle is not fastened. This may be indicative of a situation where an infant was placed in the automobile without being buckled. The output of Low battery detect 115 and the output of base latch detect 105 are input to a second AND gate 135. The output of AND gate 135 illuminates a lamp or LED when the battery voltage falls below a predetermined level, and infant carrier 210 is connected to base 205.

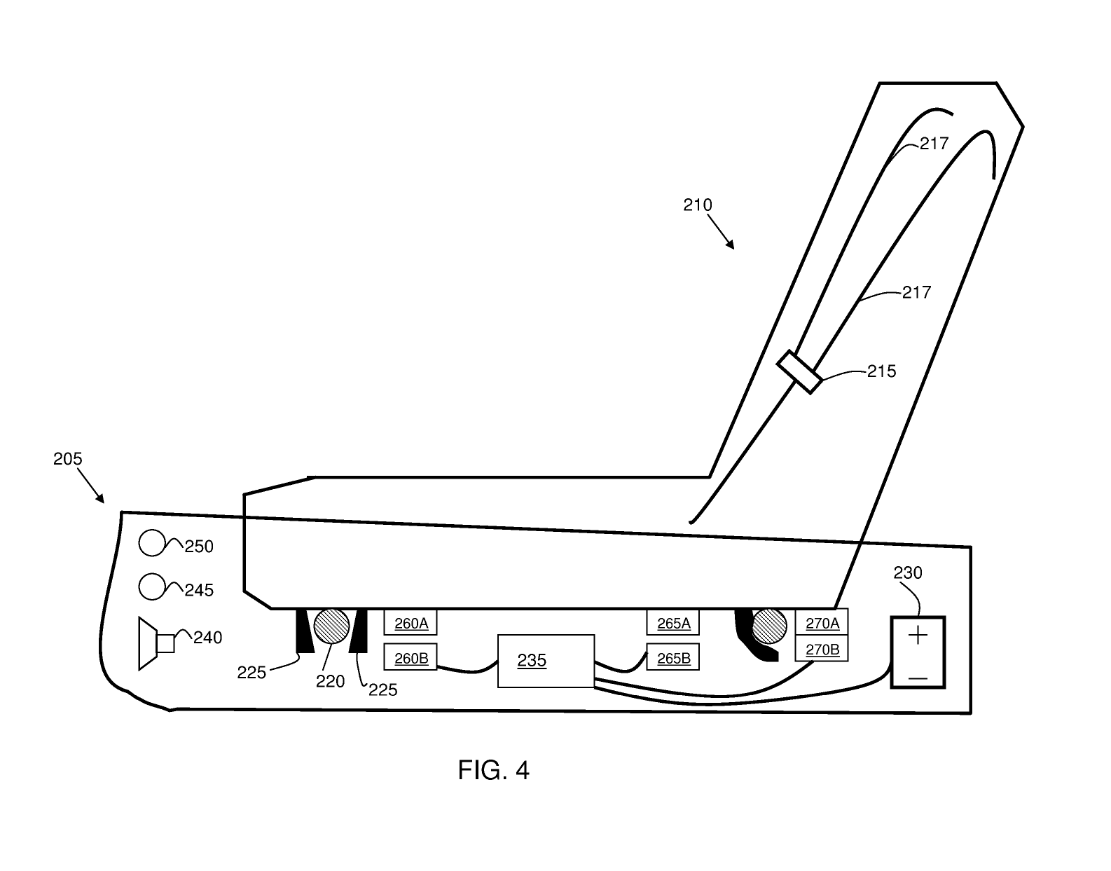

FIG. 4 is a side view of an embodiment of the present invention. Infant carrier 210 secures to base 205 during normal operation. Base 205 serves as an enclosure for a power source 230, logic circuit 235, and indication means comprising buzzer 240, latch warning light 245, and low battery warning light 250. In the embodiment shown in FIG. 4, the power source 230 is a battery. It is also possible to practice the present invention with externally supplied power. Logic circuit 235 is an example of a monitoring means for checking input from sensors and low battery conditions. Other monitoring means are possible, such as, for example, a microcontroller. Logic circuit 235 is also an embodiment of a generating means. The generating means generates a signal based on the status of all sensor input. In general, when less then all sensors provide a contact indication, an alert signal is generated. The alert signal triggers the indication means to provide an indication to the user. The generation means could also be implemented via a microcontroller. The microcontroller executes software that monitors all sensor signals, and generates an alert signal when at least one sensor indicates that contact is not made. The indication means provides feedback to the user as to whether the infant carrier 210 is properly installed on base 205. Infant carrier 210 has a plurality of clips 225 that attach to rod 220 of base 205. When clip 225 is attached to rod 220, positional sensor 260A on the infant carrier 210 couples with positional sensor 260B on base 205 to form a positional sensor pair (PSP). That is to say, each PSP comprises a positional sensor on base 205, and a corresponding positional sensor on infant carrier 210. Similarly, positional sensor 265A on the infant carrier 210 couples with positional sensor 265B on the base to form a second PSP. When all positional sensor pairs are coupled, the infant carrier 210 is deemed to be properly latched onto base 205. A PSP is considered to be coupled when the positional sensor on base 205 and the positional sensor on infant carrier 210 are aligned such that a contact signal is generated. Depending on the sensing technology used, a coupled PSP may involve physical contact between the positional sensor on base 205 and the positional sensor on infant carrier 210. Sensors that require physical contact are referred to as “contact sensors” for the purpose of this specification. If a proximity technology is used, the aforementioned positional sensors may not actually touch when the infant carrier 210 is properly installed on base 205. Sensors that do not require physical contact, but only that the sensor elements be near each other are referred to as “proximity sensors” for the purpose of this specification.

While this side view shows two positional sensor pairs, it is preferred to have a minimum of four PSP, two on each side. When all PSP are coupled, a signal within logic circuit 235 is generated, thereby providing logic circuit 235 with indication that the infant carrier 210 is latched to base 205. The PSP are positioned such that the only way that all PSP can indicate contact is when the infant carrier 210 is properly installed on base 205.

Infant carrier 210 has seat belt buckle 215. Buckle 215 contains a switch that closes when seat belt 217 is fastened to buckle 215. The closed switch completes a circuit from contact pad 270A on the infant carrier 210 to contact pad 270B on the base 205, thereby providing logic circuit 235 with indication that the seat belt 217 of infant carrier 210 is properly fastened to buckle 215.

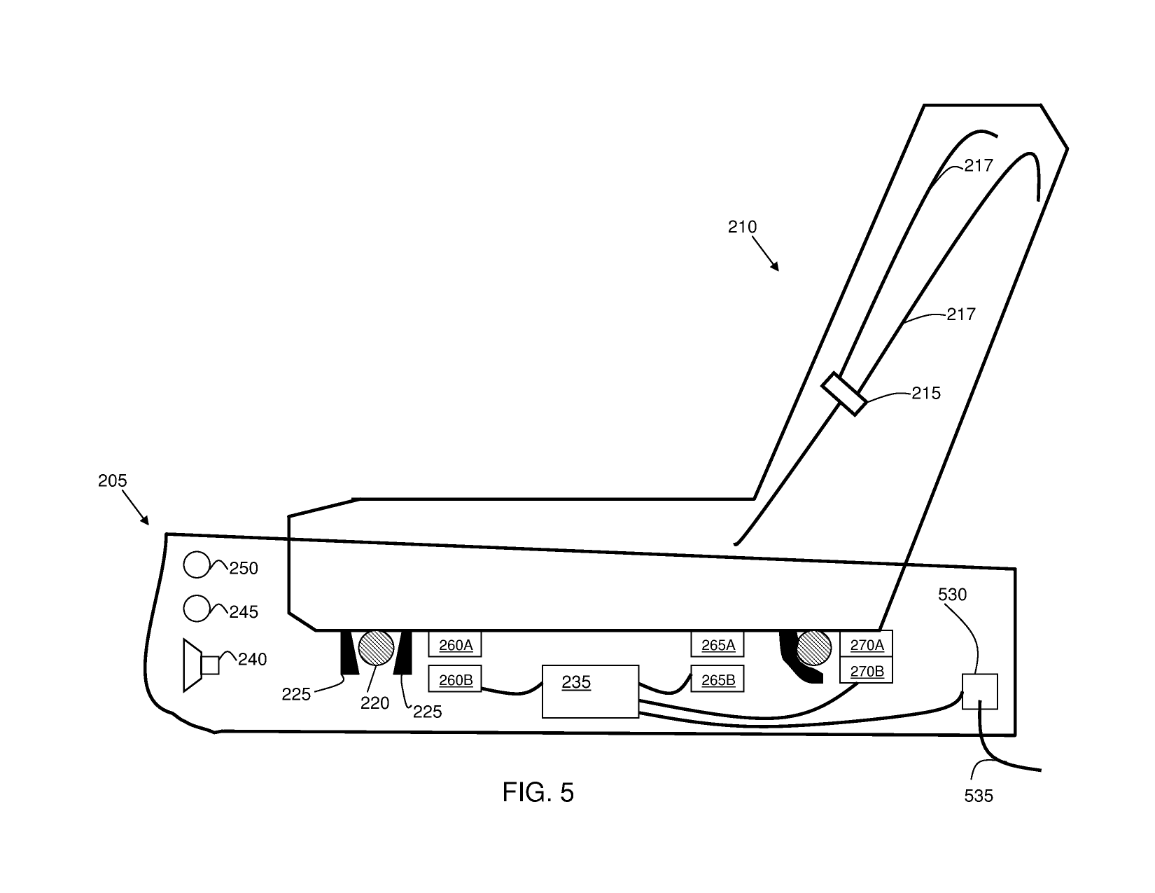

FIG. 5 shows an embodiment that is functionally similar to that of FIG. 4. The primary difference with the embodiment of FIG. 5 is that instead of a battery power source, the embodiment of FIG. 5 provides an external power connector 530. The external power connector receives power from an external power supply. The external power is preferably derived from the vehicle, for example, from the vehicle's 12 volt supply outlets. In FIG. 5, the power supply from the vehicle is indicated as 535.

Alternatively, the vehicle could provide a power outlet in the vicinity of the seat belt buckle area, such that it may be conveniently connected to the base. Although not specifically shown, it is also possible to practice the present invention with a base that has both a battery, and an external power connector. In this case, when the external power is connected, the battery power source is disconnected, and therefore not used. If the battery power source is a rechargeable batter, the battery may be recharged while the external power is connected.

In a preferred embodiment, the positional sensors are magnetically operated proximity sensors. In an alternative embodiment, they may be electrically operated contact sensors, or mechanically operated sensors.

The present invention can have various embodiments in terms of the technology used for the sensors and alert mechanisms. The most important feature of the present invention is to properly alert a caregiver when an infant is not properly secured in the infant carrier, thereby allowing the caregiver to take appropriate action before operating a motor vehicle with the infant.

What is claimed is:

1. A child seat safety system, comprising
a. an infant carrier having a seat belt;
b. a base to which said infant carrier can be fastened;
c. a plurality of positional sensors installed on said base and said infant carrier, thereby forming a plurality of positional sensor pairs;
d. monitoring means for monitoring the status of each of the positional sensor pairs;
e. generating means for generating an alert signal when at least one positional sensor pair is not coupled; and
f. indication means for indicating the presence of said alert signal to a user.

2. The child seat safety system of claim 1, further comprising means for detecting a low battery voltage condition, means for generating a low battery signal upon detection of said low battery voltage condition, and indication means for indicating the low battery voltage condition to a user.

3. The child seat safety system of claim 1, further comprising means for generating a confirmation indication signal when the infant carrier is properly inserted into the base, and indication means for indicating the presence of the confirmation indication signal to a user.

4. The child seat safety system of claim 1, further comprising a battery power source.

5. The child seat safety system of claim 1, further comprising a means for receiving power from an external power supply.

6. The child seat safety system of claim 4, further comprising a means for receiving power from an external power supply, whereby said battery power source is disconnected when power is supplied from said external power supply.

7. The child seat safety system of claim 6, wherein said battery power source is rechargeable.

8. The child seat safety system of claim 1, wherein said indication means comprises a speaker.

9. The child seat safety system of claim 1, wherein said indication means comprises one or more light elements.

10. The child seat safety system of claim 9, wherein the light elements are light emitting diodes.

11. The child seat safety system of claim 1, wherein at least one of said positional sensors pairs is comprised of contact sensors.

12. The child seat safety system of claim 1, wherein at least one of said positional sensors pairs is comprised of proximity sensors.

13. The child seat safety system of claim 1, further comprising means for detecting an unbuckled seat belt when said infant carrier is fastened to said base, said means comprising means for generating an unbuckled signal upon detection of an unbuckled seat belt, and indication means for indicating the unbuckled seat belt condition to a user.
